(19) United States
(12) Patent Application Publication
(10) Pub. No.: US 2013/0201538 A1
(43) Pub. Date: Aug. 8, 2013

(54) CHROMOPHORE BASED NANOCIRCUITS

(71) Applicants: University of Vermont, Burlington, VT (US); Tempere University of Technology, Tampere, VT (US)

(72) Inventors: Stuart Kauffman, Santa Fe, NM (US); Samuli Niiranen, Tampere, FL (US); Gábor Vattay, Erd (HU)

(73) Assignees: Tempere University of Technology, Tampere, FL (US); University of Vermont, Burlington, VT (US)

(21) Appl. No.: 13/750,980

(22) Filed: Jan. 25, 2013

Related U.S. Application Data
(60) Provisional application No. 61/590,745, filed on Jan. 25, 2012.
(60) Provisional application No. 61/613,936, filed on Mar. 21, 2012.
(60) Provisional application No. 61/714,610, filed on Oct. 16, 2012.

(51) Int. Cl. G02F 3/02; G06N 99/00

(52) U.S. Cl. CPC G02F 3/02; G06N 99/002
USPC 359/108

(57) ABSTRACT

Certain embodiments relate to systems and methods providing wires, circuits, or circuit elements comprised of one or more chromophores. The chromophores can be “tuned” to the critical edge between quantum order and quantum chaos providing long coherence times combined with quantum delocalization resulting in coherent transport of excitons. Such tuned chromophore systems provide coherent transport at room temperature.

### CROSS-REFERENCE TO RELATED APPLICATIONS

This application claims the benefit under 35 U.S.C. §119(e) of U.S. Provisional Patent Application No. 61/590,745, filed Jan. 25, 2012, and titled CHROMOPHORE BASED NANO-CIRCUITS, U.S. Provisional Patent Application No. 61/613,936, filed Mar. 21, 2012, and titled CHROMOPHORE BASED NANOCIRCUITS, and U.S. Provisional Patent Application No. 61/714,610, filed Oct. 16, 2012, and titled CHROMOPHORE BASED NANOCIRCUITS, each of which is hereby incorporated by reference in its entirety and made a part of this specification for all that it discloses.

### TECHNICAL FIELD

The systems and methods disclosed herein relate generally to the application of certain quantum coherent properties to the performance of various functions, such as providing a transition element for logical switching.

### BACKGROUND

Moore's law famously predicts an exponential growth of computational power available through an ever-increasing number of transistors in a single electronic integrated circuit. However, as the 10 nm scale is approached in integrated circuit miniaturization, quantum tunneling effects start to limit the ability to increase transistor density in an electronic, semiconductor-based integrated circuit. Even before that scale is reached, excessive heat creation of ohmic wires virtually halted miniaturization of CPU units and forced manufacturers to produce multi-core processors instead. Photonics have been offered as one solution for overcoming the various limitations of electronic circuits. However, as computation is a complex multi-signal non-linear process, the realization of optical logic requires advanced non-linear optics currently not available. Thus, there is a need for alternative architectures for achieving nano-scale electronic circuits.

### SUMMARY

Some embodiments include wires, circuits, or circuit elements comprised of one or more chromophores. For example, a nano-scale wire may be constructed by a linear chain of chromophores supported by a substrate. In some embodiments, the chromophores are “tuned” to the critical edge between quantum order and quantum chaos. While not being bound by any particular theory, it is believed the chromophores at critical quantum chaos exhibit the unique property of long coherence times combined with quantum delocalization resulting in coherent transport of excitons. Thus, in some embodiments, an input signal at one chromophore (e.g., light stimulation) generates an exciton that can then coherently transport to adjacent chromophores in a nearly frictionless manner, allowing transport of energy and information with little heat generation. In some embodiments, such tuned chromophore systems provide coherent transport at room temperature. In some embodiments, the chromophores can have a configuration that places the system in a localization-delocalization threshold, and can facilitate keeping the system in the localization-delocalization threshold, thereby enabling coherent transport of excitons.

Some embodiments include an excitonic logic gate or ‘excitonic transistor’ where the timing and intensity of incident photons serve as a switching function that affects the transport of excitons through the gate in a manner similar to the voltage response of an electronic transistor. In some embodiments, such a gate includes two or more chromophores between which an incoming exciton would oscillate. The timing and intensity of incident photons modulates the probability of the gate to pass through the exciton.

Various embodiments relate to an information or energy conveyance structure that includes a chromophore assembly with a plurality of chromophores. In some embodiments, the plurality of chromophores can have a spatial configuration that paces the chromophore assembly within a pre-determined range of quantum order. The predetermined range of quantum order can include a critical transition point between quantum order and quantum chaos. In some embodiments, the plurality of chromophores can have a spatial configuration that paces the chromophore assembly within a pre-determined range of a metal-insulator transition. In some embodiments, the plurality of chromophores can have a spatial configuration that paces the chromophore assembly within a pre-determined range of a localization-delocalization transition.

Various embodiments relate to an apparatus for performing logical operations. The apparatus can include a chromophore assembly that includes a plurality of chromophores. The apparatus can include an exciton source configured to input an exciton into the chromophore assembly. The apparatus can include a chromophore modulator configured to modulate the probability that at least one chromophore in the chromophore assembly will transmit the exciton. In some embodiments, the plurality of chromophores can have a spatial configuration that paces the chromophore assembly within a pre-determined range of quantum order. The predetermined range of quantum order can include a critical transition point between quantum order and quantum chaos. In some embodiments, the plurality of chromophores can have a spatial configuration that paces the chromophore assembly within a pre-determined range of a metal-insulator transition. In some embodiments, the plurality of chromophores can have a spatial configuration that paces the chromophore assembly within a pre-determined range of a localization-delocalization transition.

Various embodiments relate to an apparatus for performing logical operations including a first module configured to apply external driving to a transmission element such that the transmission element's degree of quantum coherence exceeds a first threshold. The first module can drive the transmission element based on a first input that is configured to receive quantum information. The apparatus can include a second module that can be configured to maintain a state associated with the transmission element within a range of a transition point. The apparatus can include a third module configured to apply time dependent forces to the transmission element thereby reducing the transmission element's degree of quantum coherence below a threshold. The apparatus can include an output configured to transmit quantum information.

Various embodiments relate to an apparatus for performing logical operations. The apparatus can include an exciton source and an output. A first chromophore structure can be coupled between the exciton source and the output. The apparatus can include a first chromophore modulator, which can be configured to modulate the first chromophore structure between an open state and a closed state. A second chromophore structure can be coupled between the exciton source and the output. The apparatus can include a second chromophore modulator, which can be configured to modulate the second chromophore structure between an open state and a closed state.

In some embodiments, the apparatus can be configured such that an exciton is transferred from the exciton source to the output when either the first chromophore structure or the second chromophore structure is in the open state.

In some embodiments, the apparatus can be configured such that an exciton is transferred from the exciton source to the output when both the first chromophore structure and the second chromophore structure are in the open state, and such that the exciton is not transferred from the exciton source to the output when either the first chromophore structure or the second chromophore structure is in the closed state.

In some embodiments, the first chromophore modulator can be configured to modulate the first chromophore structure between the open state and the closed state by adjusting quantum coherence of the first chromophore structure.

### BRIEF DESCRIPTION OF THE DRAWINGS

FIG. 1 depicts Purity decay of the chromophore ring with 1D Harper Hamiltonian. In FIG. 1, the vertical axis is probability and the horizontal axis is dimensionless time. Below the metal-insulator transition W<W_{c}=2 curves can be fitted with exponentials P(t)=exp(−t/τ_{c}). In the parameter range W=0.1-1.9 the fitted coherence time changes in the range τ_{c}=182-248. In and above the transition W≧W_{c} the curves can be fitted with P(t)=(τ_{α}/τ_{α}+t))^{α}. In the parameter range W=2.0-4.0 the exponent changes in the range α=2.01-0.479 and τ_{α}=451-1651. The estimate for the decoherence time P(τ_{c})=1/e=37% above the transition is τ_{c}=τ_{α}(e^{1/α})=266-16051.

FIG. 2 depicts the probability that the exciton stays on the chromophore it started in represented by the density matrix element τ_{1,1}. Below the transition (W=0.1) coherence dies out quickly and the probability reaches its asymptotic value 1/25. The peak at time≈13 is the result of the interference of waves going clock and anti-clockwise along the circle and meeting again after turning around the structure. The rest of the structure comes from interference of waves scattering back from other chromophores. In the transition point and above coherent beats occur and the probability stays elevated for a very long time (not shown here). These are beats due to genuine quantum coherent superposition states.

FIG. 3 depicts probability that the exciton started on chromophore 1 is on chromophore 13 ρ_{1,13}. Below the transition (W=0.1) coherence dies out quickly and the probability reaches its asymptotic value 1/25. The beats at times 6.5 and at 19.5 reflect interference from clock and anti-clockwise traveling waves interfering after taking half and 1.5 rounds. In the transition point and above we can see that due to the localization it takes much longer time for the excitation to arrive at the opposite end. If we are just slightly above the transition coherent beats smear out by the time they arrive. The reason is that propagation becomes mostly classical as localization stops quantum diffusion. In the critical point however quantum propagation and coherence is possible at the same time.

FIG. 4 illustrates a power law decay of the population probability ρ_{1,1} for the chromophore model and for the real FMO complex. The population decay for a modified version of our model is shown on log-log scale at the critical point W=2, where each site is fully correlated with its next neighbors and not correlated with the rest of the chromophores. The same quantity is shown for the FMO complex. Time scales are in arbitrary units. Both curves oscillate around a trend which decays with the same exponent of about −0.23. While the geometry is different for FMO and the ring, both of them seem to follow the same, perhaps universal, scale free trend observed at the critical point of the MIT.

FIG. 5 depicts the average localization length of the FMO complex as a function of the tuning parameter λ. The value λ=1 corresponds to the real FMO complex. For λ>1 the diagonal elements of the Hamiltonian matrix are magnified causing more localization. For λ<1 the diagonal elements of the Hamiltonian matrix are shrinked causing less localization. The localization length is the reciprocal of the inverse participation ratio ξ=1/IPR calculated as an average for all the N=7 eigenfunctions (k) and sites n of the FMO complex IPR=(Σ_{n,k=1}^{N}|ψₙ^{(k)}|⁴)/N. The localization length shows how many sites are involved in a given energy eigenfunction in average. Conversely it also shows how many energy eigenstates overlap in a given site. The value ξ=1 means that the energy eigenfunctions are localized on a single state while ξ=4 seems to be the largest level of attainable delocalization. The FMO complex is half way between the fully localized and delocalized cases.

FIG. 6 depicts transport efficiency and transport time in the FMO complex as a function of the tuning parameter λ, at optimal phase breaking γ_{φ}=300 cm⁻¹. Solid curves show transport efficiency for ambient temperatures T=277 and for the case when quantum dissipation is not present T=∞. The presence of quantum dissipation increases the transport efficiency for all parameters λ. Without quantum dissipation the delocalized systems λ<I are more efficient than the localized ones λ>1 and efficiency increases with the localization length. When quantum dissipation is present the efficiency increases with about 0.8% in the optimal point near λ≈1 and shows a maximum near the real FMO complex. (Note that the experimental parameters of the FMO Hamiltonian carry some error and the maximum cannot be expected exactly at λ=1.) Dashed lines show the transport time. There is a dramatic speedup of transport due to quantum dissipation. The transport time drops from about 7 picoseconds to 3.5 picoseconds for the FMO complex. The transport time without quantum dissipation (T=∞) changes monotonically with the localization and fastest for the most delocalized case. With quantum dissipation (T=277 K) the transport time is about minimal for the real FMO complex which is in between the localized and delocalized cases.

FIG. 7 depicts transport efficiency and transport time for the golden mean Harper model as a function of the tuning parameter. The Harper model is defined by the one dimensional chain with site energies Hₙₘ=2λJ cos(2πGn) and hopping terms H_{n,n+1}=J, where G=(\sqrt{5}−1)/2 is the golden mean and λ is the tuning parameter. If λ=1 the system is at the critical point of the localization-delocalization transition. For λ>1 all the states are localized in an infinite system and for λ<1 they are all extended. Fixing the external temperature at 277 K and the phase breaking at 300 cm⁻¹ (in spectroscopic wavenumber units) similar to the FMO complex the parameter J defines the energy scale of the model. For values J≈500-2000 cm⁻¹ the phase breaking seems to be optimal in a chain of length N=30 and the best efficiency and the smallest transport time is attained at the critical point of the metal-insulator transition at λ=1. Solid lines show transport efficiency for J=500, 1000 and 2000. Dashed lines show the transport time for the same cases. The best transport efficiency and shortest transport time is reached at the critical point between localization and delocalization at λ=1. The transport time of 20 picoseconds is in accordance with the trapping rate 1/κ=1 ps and the Boltzmann factor giving probability ρᵣᵣ=1/20 at the exit of the chain n=30 at 277 K.

FIG. 8 illustrates a schematic diagram of an “excitonic transistor” as contemplated in certain embodiments.

FIG. 9 illustrates a pair of excitonic transistors arranged so as to form an AND logic gate.

FIG. 10 illustrates a pair of excitonic transistors arranged so as to form an OR logic gate.

### DETAILED DESCRIPTION OF CERTAIN EMBODIMENTS

### System Overview

Implementations disclosed herein provide systems, methods and apparatus for generating “excitonic transistors” and similar devices. Discovery of room temperature quantum coherence in the avian compass of birds, in the olfactory receptors and in light harvesting complexes in the last few years indicate that quantum effects might be ubiquitous in biological systems. While the quantum chemical understanding of certain details of light harvesting systems is almost complete, no organizing principle has been found which could explain why quantum coherence is maintained in these systems for much longer than the characteristic decoherence time imposed by their room temperature environment. Here we propose that at the critical edge of quantum chaos, coherence and transport can coexist for several orders of magnitude longer than in simple quantum systems. Quantum systems changing from integrable to quantum chaos pass through critical quantum chaos which is also a metal-insulator transition from Anderson localization to extended wave functions. By extending the semiclassical theory of decoherence from chaotic and integrable systems to the transition region we show that coherence decay changes from exponential to power law behavior and coherence time is amplified exponentially from its environmentally determined value. This result can be demonstrated on a ring of chromophores passing through the critical point where coherence in the critical point decays with the same non-trivial power law as in the FMO complex experiment. Our results also show that loss of coherence is not permanent in these systems and they can re-cohere via coherent external driving such as the arrival of photons in case of the light harvesting systems and can continuously hover in a “Poised Realm” between the coherent quantum and the incoherent classical worlds (see PCT Application No. PCT/US2011/044738 for discussion of this “Poised Realm”, which is incorporated herein by reference in its entirety). Some embodiments include using this new critical design principle from biology to build lossless quantum coherent energy and information processing devices operating at room temperature.

Quantum biology is dealing with open quantum systems closely coupled to their many degrees of freedom environment. The environment exerts time dependent forces on the system through the coupling. Some of these forces change very rapidly compared to the excitation frequencies of the system and look random from its point of view. This “heat bath” destroys quantum coherence and moves the system into a mixed state rapidly. The average effect of the random forces can be described as a non-unitary time evolution of the system's density matrix.

At room temperature the phonon environment has characteristic energy E_{T}=k_{B}T≈4·10⁻²¹J and frequency νᵣ=k_{B}T/h≈6 THz in the infrared spectrum. The typical phonon thermal wavelength is determined by the speed of sound of the material the system is embedded in. Its typical value for water and non-specific proteins is c=1500 m/s yielding λ_{T}=c/ν˜2.5 Å. Molecules within a thermal wavelength distance can feel the same environment and some of their states can be almost decoherence free and can preserve coherence for a relatively long time. In light harvesting systems the light absorbing and emitting chromophores are embedded in a protein scaffold which can suppress thermal fluctuations more effectively. The thermal wavelength can be increased to 10-13 Å by raising the effective speed of sound with a factor of 3-5 to 7-8000 m/s. Protective environments cannot extend the size of coherent patches further and a different mechanism is needed to extend it further, which we propose next.

The speed of environmental decoherence can be characterized by the decay rate of the off diagonal (n≠m) elements of the reduced density matrix of the system ρₙₘ˜e^{-t/τc}, where τ_{c} is the coherence time. Purity P=Tr[ρ²]=Σₘₙ|ρₙₘ|² has been shown to be a good overall measure. It is P=1 when the system is in a pure state and decreases monotonically as the system decoheres into a mixed state. P(t)˜1/N+const·e^{-t/τ}^{_{c}}, where N is the number of quantum states of the system. The logarithm of the purity is the Renyi entropy S₂=log Tr[ρ²] of the system. The long time entropy production rate of the system and the rate of decoherence are then closely related dS₂/dt˜1/τ_{c} for t→∞. Entropy production on the other hand is determined by the dynamical properties of the system. It has been derived via semiclassical approximation and then proven by direct simulations that the entropy production rate becomes environment independent and is determined by the classical dynamical Kolmogorov-Sinai entropy of the system. It is in turn the sum of the positive Lyapunov exponents λᵢ⁺ characterizing the exponential divergence of chaotic trajectories in the system dS₂/dt˜h_{KS}=Σᵢλᵢ⁺. This relation between coherence decay and generalized Lyapunov exponents has been confirmed in strongly chaotic systems. Another implication of this result is that the rate of decoherence vanishes in systems where the Lyapunov exponent is zero. This has also been confirmed in integrable systems. These are completely solvable systems with fully predictable regular dynamics and zero Lyapunov exponents. Purity shows power law decay typically like P(t)˜1/t² and asymptotic decoherence rate is zero dS₂/dt˜1/t→0.

Zero Lyapunov exponent and entropy production can also emerge in systems at the border of the onset of global chaos in the classical counterpart of the system. Suppose we have a parameter ε of the mechanical system which characterizes its transition from regular dynamics to chaos. H=H_{R}+εH_{C}, where H_{R} is the Hamiltonian of a fully integrable system and H_{C} is fully chaotic. Classically H_{R} is a solvable system and it can be described by actionangle variables. It does only simple oscillations in the angle variables while the action variables do not change and remain conserved restricting the dynamics for the surface of a torus in the phase-space. When ε≠0 but small the system is not integrable classically and the Kolmogorov-Arnold-Moser (KAM) theory describes the system. The chaotic perturbation breaks up some of the regular tori in the phase-space and chaotic diffusion emerges localized between unbroken, so called KAM tori. Chaotic regions are localized in small patches in the phase-space surrounded by regular boundaries represented by the KAM tori. At a given critical ε_{c} even the last KAM tori separating the system gets broken and the chaotic patches merge into a single extended chaotic sea. In the transition region ε≈ε_{c} the Lyapunov exponent shows a second order phase transition with power law scaling λ₀(ε)˜(ε−ε_{c})^{β} slightly above ε>ε_{c} with some exponent β>0. Above the transition ε>ε_{c} the system is chaotic characterized by a positive largest Lyapunov exponent λ₀>0.

On the quantum mechanical level we can follow the transition in the statistical distribution of the energy levels. The Hamilton operator of the regular system H_{R} is a separable with diagonal 4 matrix elements. The consecutive energy levels of the regular system look random and follow a Poisson process. The nearest neighbor level spacing distribution is then exponential p(s)=exp(−s), where sₙ=(Eₙ₊₁−Eₙ)/Δ(Eₙ) is the level spacing measured in the units of local mean level spacing Δ(E) at energy E. The Hamiltonian operator H_{C} corresponding to the fully chaotic system is best approximated by a random matrix. The energy level statistics of H_{c} can be described by Random Matrix Theory (RMT) and the level spacings follow the Wigner level spacing distribution p(s)=(π/2) exp(−πs²/4) in systems with time reversal symmetry. As the parameter c is increased from zero the level spacing statistics changes from a Poissonian to a Wigner distribution. Critical quantum chaos sets up at the critical value ε_{c} in between. Below the critical point p(0) is finite, at the critical point and above the spacing distribution starts linearly p(s)=As for s→0, a characteristic feature of chaotic systems with strongly overlapping eigenfunctions. The tail of the distribution remains exponential below the critical point, exp(−Bs) for s→∞, which is a characteristics of regular systems whose eigenfunctions do not overlap for larger energy separations. It turns to Gaussian, exp(−Cs²), then above the critical point. At the critical point the level statistics is semi-Poisson, p(s)=4s exp(−2s), which starts linearly and decays exponentially combining the two main aspects of the level statistics of regular and chaotic systems.

The transition described here is more general than just the transition from regular to quantum chaotic behavior. It is also a transition from the localized states of the regular system to the extended states of the chaotic system. The two are separated by the metal-insulator transition (MIT) point between quantum mechanical Anderson localization and globally delocalized metallic phase. The transition point can be identified with the emergence of the semi-Poissonian level statistics. In the transition point the wave functions are neither fully localized nor extended and have an intriguing multi-fractal spatial character. The fractal structure allows them to develop a hairy localized structure but also an extended structure with long range overlap correlations.

Merging the pieces of classical, semiclassical and quantum aspects a new picture emerges. Systems well below the critical point have non-chaotic dynamics with zero generalized Lyapunov exponents and quantum localization lengths extending only for few states. Decoherence in these systems is slow and purity follows a power law decay P(t)≈1/t^{α} with some exponent a making possible the presence of anomalously long living coherent dynamics in the system. But coherently evolving states remain localized and long distance quantum coherent transport is not possible. Systems well above the critical point have chaotic dynamics with positive Lyapunov exponents and delocalized states extending for the entire system. Coherence dies out exponentially fast. Near the critical point exponential decay of coherence crosses over to long living power law behavior and localized states become delocalized. In finite systems there is always a narrow region around criticality, where long living coherence and sufficiently extended states can exist at the same time.

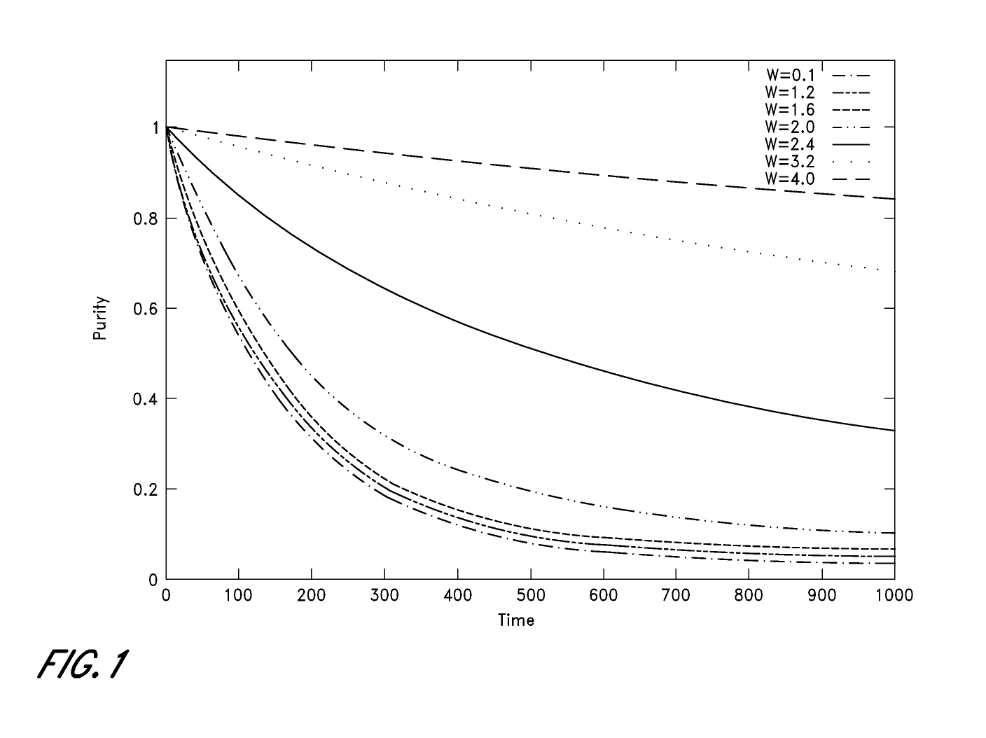

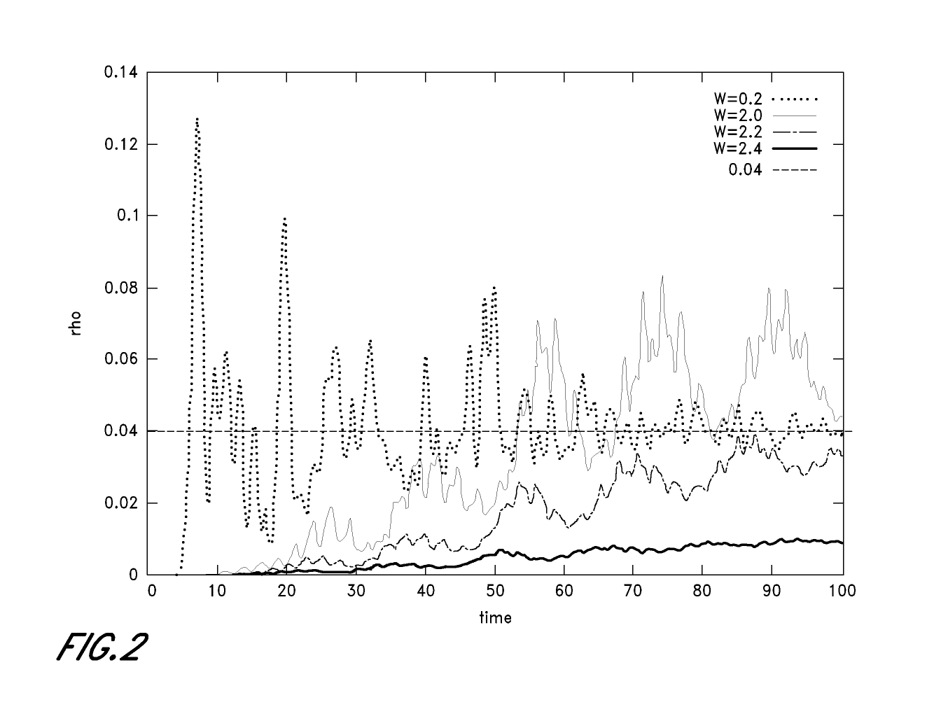

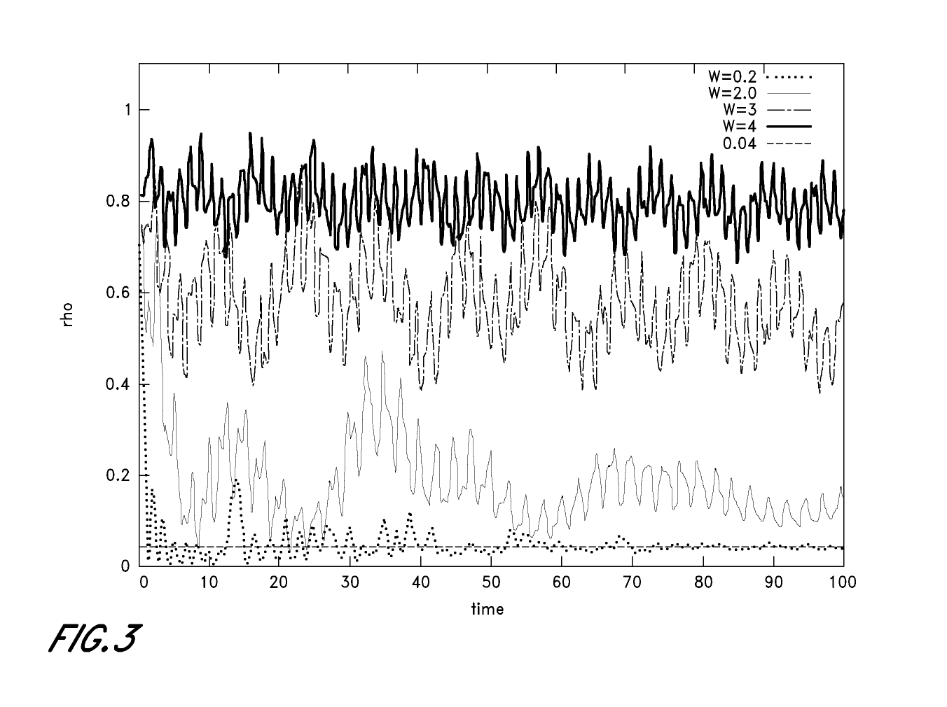

This result can be demonstrated on a simplified model of chromophores in light harvesting complexes. It is very likely that biological systems use this mechanism to tune their parameters near the critical point to maintain rich quantum transport properties. The excitonic states are described in the single excitation approximation by the Hamiltonian Hᵢⱼ=ΣᵢEᵢ|i [symbol] [symbol] i|++ΣᵢⱼVᵢⱼ|i [symbol] [symbol] j| where |i [symbol] indexes the excitonic states with site energies Eᵢ and dipole interaction strengths Vᵢⱼ. For simplicity we take a simple ring of L chromophores coupled by constant Vₙₘ=1 for neighboring sites n and m and zero otherwise and take quasi random on site energies given by Eₙ=W cos(2πσn), where the irrational number σ=(√5−1)/2 is the golden mean. This Hamiltonian is known as the one dimensional Harper model. At W_{c}=2 the infinite system L→∞ goes through a MIT with delocalized states below and localized states above criticality. At the critical point it has been shown to have semi-Poisson level statistics. The system is coupled to the phononic environment via the Hamiltonian ΣᵢF(xᵢ, t)|1 [symbol] [symbol] i|, where F(x, t) is the randomly fluctuating phonon field including the chromophore site energy coupling constant. The reduced density matrix of the chromophore system can be described in Markovian approximation by the Lindblad equation

$${\partial }_{t} {ρ}_{n m} = {\frac{1}{i ℏ} [ H , ρ ]}_{n m} - \frac{1}{{ℏ}^{2}} ( {C}_{nn} + {C}_{m m} - 2 {C}_{n m } ) {ρ}_{n m} , \qquad ( 1 )$$

where Cₙₘ= [symbol] F(xₙ,t)F(xₘ, t) [symbol] is the correlation function of the environmental coupling. We assume that the correlation function depends only on the periodic distance of the chromophores in a simple way Cₙₘ=D(L/π)² cos²(π(n−m)/L) and is quadratic for small distances. Next we show results for L=25 (in dimensionless units [symbol] =1), which is a realistic number of chromophores in experimentally investigated systems. In FIG. 1 we show purity of the system. Below the critical point purity decays exponentially. At and above the critical point the curves can be fitted with power law exponents changing from α≈2 at criticality towards zero as W increases and the curves flatten out. In FIG. 2 we show the probability ρ_{1,1} to find the exciton on the chromophore in which the exciton was initialized. Below criticality the probability reaches its asymptotic value of 1/L=0.04 quickly after decaying coherent oscillations. Above criticality the probability stays above the asymptotic value for a long time indicating the presence of localization. Quantum beats can be observed which also relax in a very slow fashion. Based on the simulations we can establish the rule of localization assisted amplification of coherence time. In the delocalized regime purity decays exponentially determined by the timescale dictated by the environment. In the localized regime we can define an effective coherence time by looking at the point where purity decays to 1/e of its original value P(τ_{c})=1/e. Above the critical point purity can be well approximated by function P(t)=(τ_{α}/(τ_{α}+t))^{α} (see FIG. 1). The effective length of coherence then can be approximated as τ_{c}=τ_{α}·(e^{1/α}−1). This function grows very fast when α→0 in the strongly localized limit. In our example this is a 60-fold increase between criticality and W=4. In FIG. 3 we show the probability ρ_{13,13} of finding the excitation at the opposite end of the ring. For subcritical values the excitation arrives very quickly due to delocalization and shows beats due to the interference of excitons traveling clock and anti-clockwise. Coherent beats die out quickly and we reach the asymptotic probability. For supra-critical values far from the critical point the probability to reach site 13 remains astonishingly low due to the localization of the system. For values near at and below criticality we get the most optimal results for quantum coherent transport of excitations, when excitations can still reach the opposite end of the circle but can preserve a degree of coherence as well.

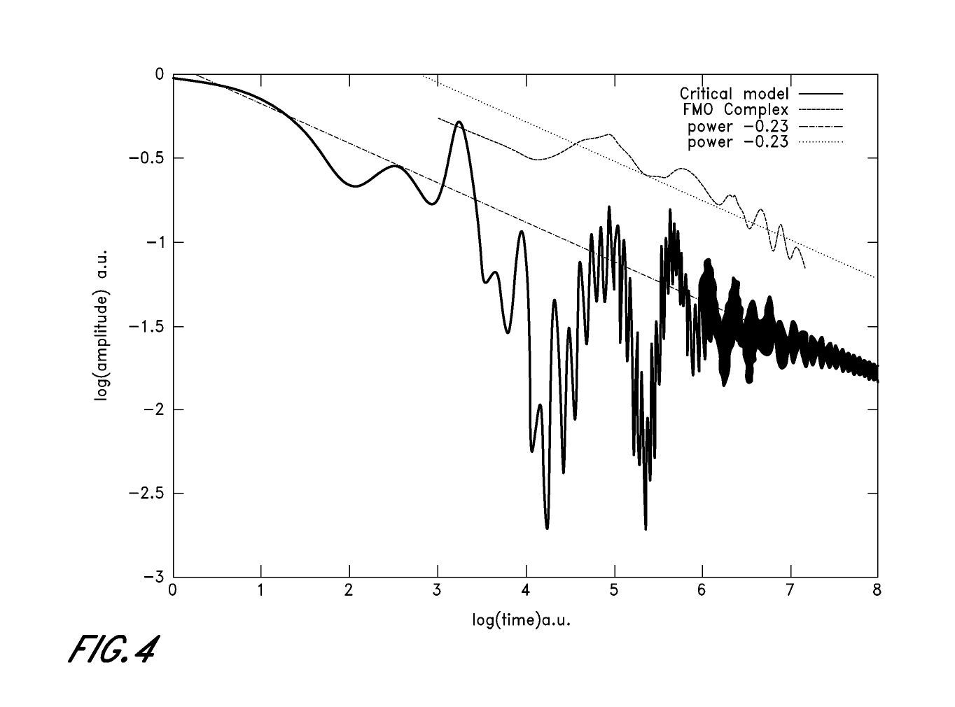

At criticality not only purity changes from exponential to power law decay but so does the population of the chromophores. In FIG. 4 we show the population ρ_{1,1}(t) in a version of our model where three neighboring chromophores along the circle are always fully correlated Cₙₘ=C while they become totally uncorrelated otherwise Cₙₘ=C→∞. This model can describe the real situation where neighboring chromophores are shielded from the environment by their protein scaffolds and approximately three chromophores can be placed within the protected thermal wavelength of 10-13 Å. We can see that the trend of the population follows a shallow power law decay. We show also experimental data on the FMO light harvesting complex. Both curves follow a similar scale free trend with approximately the same exponent −0.23. The explanation can be that while the two systems are different in detail they both show the same universal scaling at criticality, indicating that the Hamiltonian of the FMO complex is tuned to critical quantum chaos in order to realize optimal coherent transport. We further note that this exponent is very close to −0.25 which is the power law decay exponent of the average return probability p(t)= [symbol] pₙ(t) [symbol] ₙ˜t^{-1/4} at the critical point of MIT. The return probability p(t)= [symbol] |ψₙ(t)|² [symbol] is the probability of return assuming that the wave function was localized on the site initially ψₙ(0)=1. In the decoherence free case it coincides with the density matrix element ρₙₙ(t) assuming ρₙₙ(0)=1, which is shown in our model and for the FMO complex. It seems likely that the FMO complex follows the universal scaling of critical MIT indicating that the Hamiltonian of the FMO complex is tuned to critical quantum chaos in order to realize optimal coherent transport, what we show elsewhere.

The findings support a new approach to quantum biological systems. They are not just under the influence of environmental decoherence due to random noise but also driven by the coherent waves of the incoming photons. The photons are absorbed by one of the chromophores which can be interpreted as a measurement process selecting one of the chromophores randomly. Then the system is set into an initial state which is concentrated on the selected chromophore. The purity of the system becomes P=1 as this is a pure state and the partially decoherent evolution starts again decreasing the purity in time. The system can hover in the “Poised Realm” between clean quantum and incoherent classical worlds (see PCT Application No. PCT/US2011/044738, which is incorporated herein by reference in its entirety). By tuning the timings of re-coherence events and the coherence time during decoherence via tuning the system on the chaos-regularity axis can be kept in high level of purity. This makes it possible to create new quantum devices working at room temperature capable of nearly frictionless quantum transport of energy and information.

In some instances, quantum dissipation can play an important or essential role in the quantum search performed in the FMO complex. While is has been conjectured that light harvesting complexes such as the Fenna-Matthews-Olson (FMO) complex in green sulfer bacteria may perform an efficient quantum search similar to the quantum Grover's algorithm, the analogy has not been clearly established. The quantum search performed in the FMO complex is fundamentally different from Govenor's algorithm. It is something new not considered in quantum computation before. In the FMO complex not just the optimal level of phase breaking is present to avoid both quantum localization and Zeno trapping but its evolutionary design can harness quantum dissipation as well to speed the process even further up. With detailed quantum calculations taking into account both phase breaking and quantum dissipation we show that the design of the FMO complex has been evolutionarily optimized and works faster than pure quantum or classical-stochastic algorithms. Some embodiments utilize this new computational concept poised between the quantum and classical realms. The new computational devices can also be realized on different material basis, opening new magnitude scales for miniaturization and speed. In passing, we also derive a new equation generalizing the Caldeira-Leggett equation of quantum dissipation for arbitrary system Hamiltonians and system-bath couplings.

Some biological systems can benefit from quantum effects even at room temperature. It has been shown experimentally that quantum coherence can stay alive for an anomalously long time in light harvesting complexes. In these systems excitons initiated by the incoming photons should travel really fast throughout a chain of chromophores in order to reach the reaction center where they are converted to chemical energy. Excitons decay within 1 nanosecond and dissipate their energy back to the environment if they cannot find the photosynthetic reaction center via random hopping on the chromophores within that characteristic time. With classical diffusion via thermal hopping that time is easily consumed and evolution should have found more optimal ways to reach that goal. Quantum mechanics is very helpful in this respect as it allows the system to explore many alternative paths in parallel and can discover the optimal one faster than a classical random search would do. However, quantum mechanics has adverse effects too. Anderson localization can prevent excitons to travel large distances from their origins. Coupling the system to the environment breaks phase coherence and can destroy the negative effects of quantum localization. Too much phase breaking however slows down the propagation again via the Zeno effect. At the right amount of phase breaking environmental decoherence and quantum evolution collaborate to achieve optimal performance and efficiency. The Environment Assisted Quantum Transport (ENAQT) theory accounts for the interplay of these two effects and can explain the existence of a transport efficiency optimum at room temperature relative to both pure quantum or pure classical transport. ENAQT explains the quick quantum exploration of the search space at optimal phase breaking. Once the exciton can reach nearly ergodically the chromophore sites random trapping delivers of the exciton to the reaction center.

While ENAQT assures the fast spreading of probability over the light harvesting complex, it does not guide the exciton to the reaction center. The reason for this is that quantum mechanics and phase breaking leads to a uniform probability distribution over the state space. The reduced density matrix of a system with Hamiltonian H is described by the Lindbad equation

$${\partial }_{t} ρ + \frac{1}{ℏ} [ H , ρ ] = \frac{1}{2} {\sum }_{j} [ {V}_{j ρ} , {V}_{j}^{+} ] + [ {V}_{j} , ρ {V}_{j}^{+} ] , \qquad ( 2 )$$

where the operators Vⱼ describe the coupling of the system and the environment. In light harvesting systems the Hamiltonian Hₙₘ is a discrete, where the chromophore sites are indexed by n=1, . . . , N. In case the chromophores are coupled to the environment independently the generators are simply diagonal Vⱼ=\sqrt{γ_{φ}}·|j [symbol] [symbol] j|, where γ_{φ} is the rate of phase breaking. The Lindblad equation keeps the density matrix normalized during the evolution Tr{ρ}=1 and its diagonal elements ρₙₘ stay positive and give the probability of finding the exciton on site n. At the optimal level of phase breaking the system relaxes quickly to the uniform probability distribution ρₙₘ=1/N. Trapping to the reaction center is described by the imaginary Hamiltonian −ih-κ| [symbol] [symbol] r|, where r is the site of the reaction center and κ is the trapping rate. Assuming rapid relaxation to the uniform distribution the bulk of the time an exciton needs to get trapped by the reaction center is determined by the fraction of time it spends on the chromophore of the reaction center. The reaction center is able to catch an exciton sitting on it in average time 1/κ and the exciton spends ρᵣᵣ fraction of its time on the chromophore. The average transport time is then the product [symbol] τ [symbol] ≈1/(ρᵣᵣκ)=N/κ. One of the best studied light harvesting systems is the FMO complex which consists of N=7 chromophores. We use this example in some cases herein. It has been shown that ENAQT is optimal in this system at phase breaking rates of γ_{φ}=300 cm⁻¹ corresponding to room temperature. At trapping rate 1 ps⁻¹ the exciton needs about 7 ps to reach the reaction center, which is consistent with this estimate.

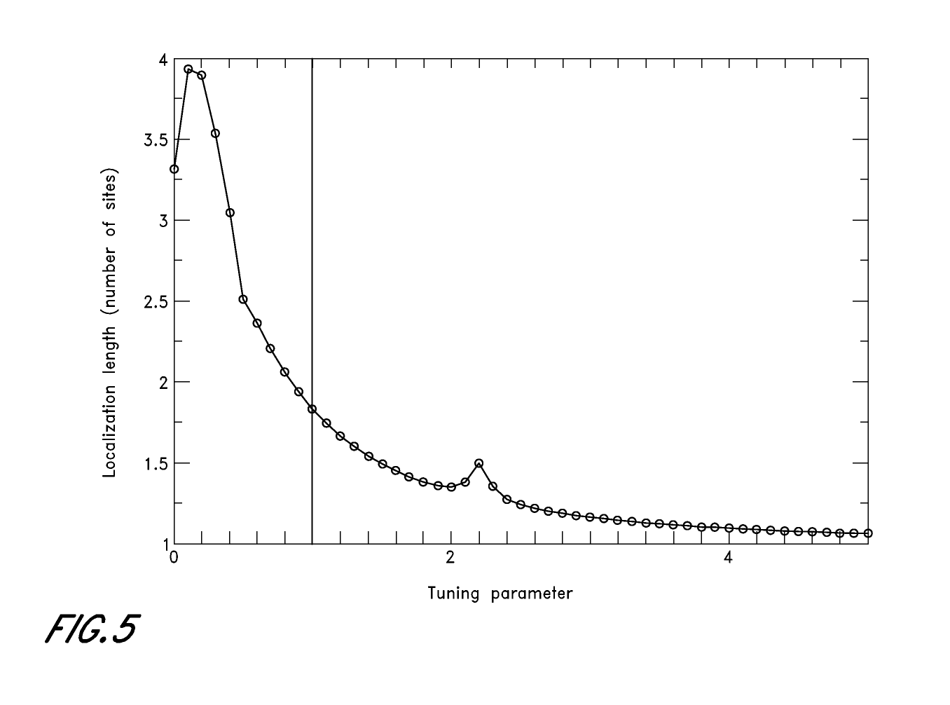

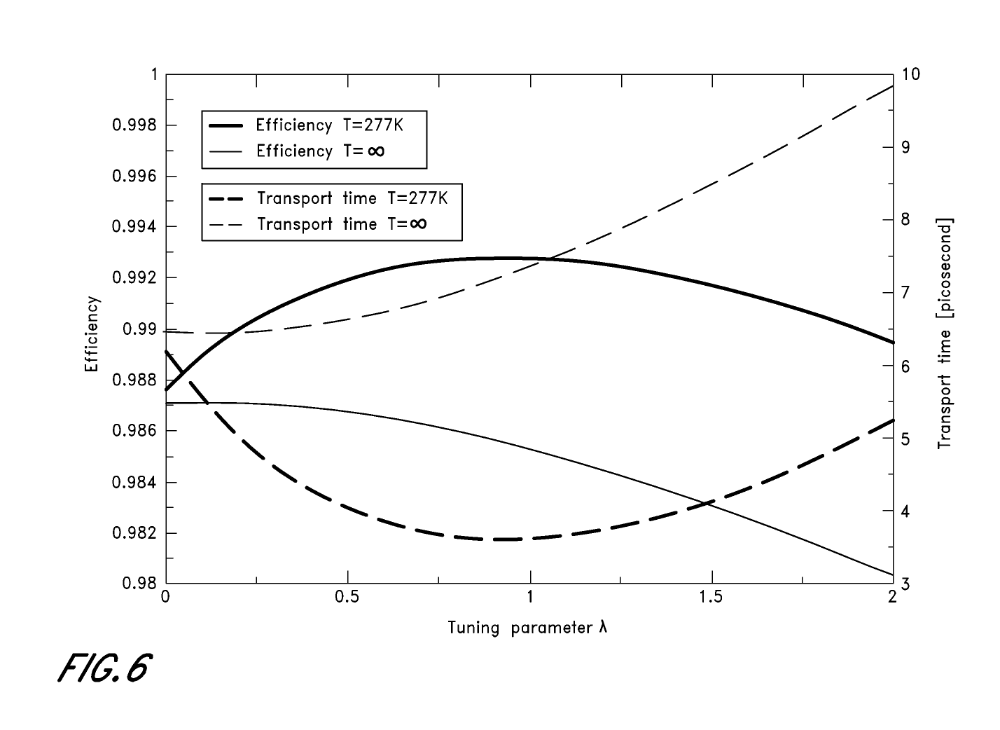

Since at optimal phase breaking the transport time depends only on the number of sites and on the trapping rate the concrete form of the FMO Hamiltonian plays no role as long as the relaxation to the uniform distribution is sufficiently fast. Accordingly, Hamiltonians with extended wave functions should be slightly more efficient than localized systems since the exciton is not trapped and the relaxation to the uniform distribution is somewhat faster. We demonstrate this in case of the FMO complex where the Hamiltonian Hₙₘ has been obtained from spectroscopy. The diagonal part of the Hamiltonian consists of the site energies of the chromophores. The off diagonal hopping terms describe the transition between sites. We can modify the localization properties of this Hamiltonian by rescaling the diagonal elements relative to the off diagonal elements H′ₙₘ=Hₘₘ+(λ−1)δₙₘHₙₘ, where λ, is the tuning parameter. For λ=1 we recover the original Hamiltonian. For λ>I the diagonal elements become larger and the system becomes completely localized for λ→∞, while for 0≦γ<1 the system becomes more extended. FIG. 5 shows the average localization length of the FMO Hamiltonian. It changes almost monotonically with λ. In FIG. 6 we show the transport efficiency and transport time as a function of λ at optimal phase breaking calculated with the parameters found in Patrick Rebentrost, Masoud Mohsemi, Ivan Kassal, Seth Lloyd and Aln Aspuru-Guzik, Environment-Assisted Quantum Transport, New Journal of Physics 11 (2009) 033003, which is incorporated herein by reference in its entirety. Both of them change monotonically with λ and the transport is slightly more efficient and faster for the delocalized case as we expected. The real FMO complex at λ=1 is not optimal in any sense. As we show next, evolution optimized the transport process further by guiding the excitons to the reaction center which sits at the lowest energy site and the design of the FMO complex is in fact highly optimal. To show this we have to go beyond the Lindblad equation in order to account for the relaxation to thermal equilibrium.

One way to study the relaxation to the correct thermal equilibrium is to use the Redfield equations describing the interaction of the system and the environmental bath. The Redfield equation can be cast in a form similar to the Lindblad equation

$${\partial }_{t} ρ + \frac{1}{ℏ} [ H , ρ ] = {\sum }_{j} [ {V}_{j}^{+} , ρ , {V}_{j} ] + [ {V}_{j} , ρ {V}_{j}^{-} ] , \qquad ( 3 )$$

where the operators can be written in energy representation as [Vⱼ⁺]_{ab}=[Vⱼ]_{ab}/(1+e^{β(E}^{ₐ}^{-E}^{_{b}}⁾) and [Vⱼ⁻]_{ab}=[Vⱼ]_{ab}/(1+e^{-β(E}^{ₐ}^{-E}^{ₐ}⁾). The operators coupling the bath and the environment are physical observables hence self-adjoint Vⱼ=Vⱼ⁺. The equilibrium solution of this equation is the Boltzmann distribution ρ=exp(−βH)/Z, where Z=Tr{exp(−βH)} is the partition function. The uniform distribution is recovered for infinite temperature β=0.

For high temperatures we can expand this equation for small β. The first two terms in the expansion arc basis independent

$${\partial }_{t} ρ + \frac{1}{ℏ} [ H , ρ ] = \frac{1}{2} {\sum }_{j} [ {V}_{j} , [ {V}_{j } , ρ ] ] + \frac{β}{2} [ {V}_{j} , \{ [ H , {V}_{j} ] ρ \} ] , \qquad ( 4 )$$

while the third term in the expansion is zero in general. The first term is the Lindblad equation for self-adjoint operators Vⱼ. The second term describes quantum dissipation, which is missing from the Lindblad equation. Caldeira and Leggett (CL) showed that the reduced density matrix of open quantum systems coupled to a high temperature bath experience both phase breaking and quantum dissipation and satisfy the equation

$${\partial }_{t} ρ + \frac{1}{ℏ} [ H , ρ ] = \frac{1}{2} {γ}_{φ} [ x , [ x , ρ ] ] - \frac{i ℏ β}{2 m} {γ}_{φ} [ x , \{ p , ρ \} ] . \qquad ( 5 )$$

Our new equation (4) gives back the CL equation as a special case for the Hamiltonian

$$H ( x , p ) = \frac{1}{2 m} {p}^{2} + U ( x )$$

with coupling V=\sqrt{γ_{φ}}x and it is valid for a much larger class of Hamiltonians and operators V. In particular for discrete Hamiltonians Hₙₘ describing the exciton dynamics in light harvesting complexes and for environmental couplings Vⱼ=\sqrt{γ_{φ}}·|j [symbol] [symbol] j| it takes the form

$${\partial }_{t} {ρ}_{n m} + {i [ H , ρ ]}_{n m} = 2 {γ}_{φ} ( 1 - {δ}_{n m} ) {ρ}_{n m} - ( 1 - {δ}_{n m} ) \frac{{γ}_{φ} β}{2} {\{ h , ρ )}_{n m} - \frac{{γ}_{φ} β}{2} ( {H}_{n m} {ρ}_{m m} + {ρ}_{nn} {H}_{n m} - {H}_{nn} {ρ}_{n m} - {ρ}_{n m} {H}_{m m} ) . \qquad ( 6 )$$

The most important feature of this equation is that the quantum dissipative term cannot be chosen arbitrarily in models of exciton dynamics. The Hamiltonian and the generators Vⱼ determine both phase breaking and dissipation uniquely. Also the order of magnitude the dissipative term relative to the phase breaking term is determined by the ratio of the size of the typical Hamilton matrix element and the temperature. In light harvesting systems these are comparable and quantum dissipation cannot be neglected.

Quantum dissipation speeds up the transport process in light harvesting complexes. If the site energies at the reaction center are lower than in the other parts of the complex the equilibrium density is higher and the exciton spends longer time on the chromophore related to the reaction center and is trapped with higher probability. The average time is again [symbol] τ [symbol] =1/(κρᵣᵣ) but now the probability is given by the Boltzmann factor ρᵣᵣ= [symbol] r|e^{-βH|} [symbol] ^{/Z . In case of the FMO complex this probability is about} 40% and the transport time would drop to a mere 2.5 picoseconds in this approximation at optimal phase breaking. Our detailed calculation using the Redfield operators outlined in the supplementary material yields about 3.5 picoseconds which is very close to this estimate and less than half than it would be without quantum dissipation. We can now ask in what sense is this result optimal? Could we achieve a better result by choosing as deep site energy as possible so that ρᵣᵣ≈1 can be achieved? We show next that this absolute optimum cannot be attained and the real FMO operates with the best transport time possible physically and evolutionarily.

At the optimal phase breaking of ENAQT quantum dissipation introduces a trade-off between fast relaxation to the equilibrium distribution and the shape of the equilibrium distribution. The equilibrium density matrix can be expressed in terms of the energy eigenstates ψₙ^{(k)} as

$${ρ}_{n n} = {\sum }_{k} {\vert {ψ}_{n}^{( k )} \vert}^{2} \frac{{e}^{- β {E}_{k}}}{Z} . \qquad ( 7 )$$

If the system is completely delocalized the wave functions are extended |ψₙ^{(k)}|²≈1/N and the diagonal elements of the density matrix become uniform ρₙₘ≈1/N independently of the energy levels Eₖ of the system. In this case the relaxation to the equilibrium is fast since the extended wave functions overlap strongly with the exciton starting on one of the chromophores, but the exciton spends time on each chromophore nearly equally. If the system is strongly localized the wave functions are concentrated on single sites |ψₙ^{(k)}|≈δₙₖ and ρₙₘ≈e^{-βE}^{ₙ}/Z, where the energy levels are close to the site energies Eₙ≈Hₙₙ. To have localization the site energies should be much larger than the hopping terms in the Hamiltonian. In equilibrium the exciton would spend a long time in the neighborhood of the chromophore with the lowest site energy, but the relaxation time to this equilibrium is very large. The overlap of the wave function localized on the lowest energy site with the initial site of the exciton is very small and the exciton stays localized near to its entry site for a very long time. In FIG. 6 we show both the transport efficiency and transport time for the FMO complex at the optimal phase breaking for different λ-s tuning the localization length of the system. For λ>1 we see a fast drop of transport efficiency and increase of transport time due to the slow relaxation hampered by the localization of the exciton. For λ<1 we see also a monotonic drop of efficiency due to the flattening of the equilibrium distribution. The shortest transport time and highest efficiency is near the real FMO complex λ≈1, where the states are neither too localized nor too much extended and realize the trade-off. Note, that the Hamiltonian is reconstructed from experiments and it carries some level of error. In FIG. 5 we can see that the localization length of the real FMO is just half way between the fully localized case, where the wave functions are concentrated on a single site and the maximally delocalized case, where the states are spread the most.

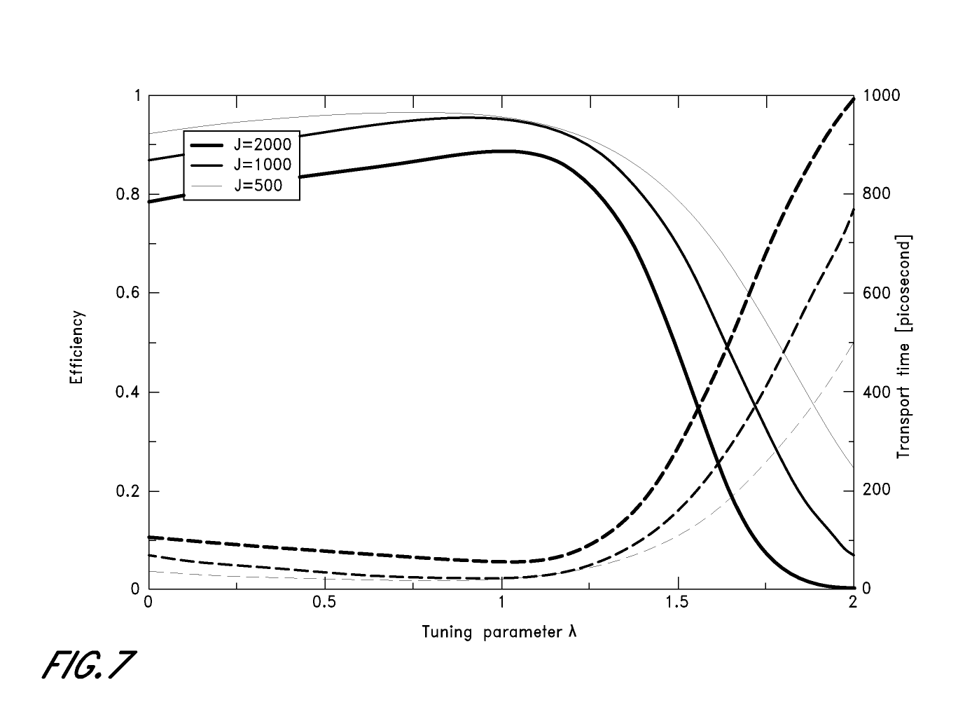

We think that this picture is quite general. If we consider larger transport systems the optimum would again lie somewhere midway between the extended and localized cases. Since the localization-delocalization transition is getting sharper with increasing system size these systems can be found (e.g., may only be found) at parameters near the metal-insulator threshold. To demonstrate this in FIG. 7 we show the transport efficiency for the golden mean Harper model which is one of the simplest models on which the metal-insulator transition can be studied. In this model we can see qualitatively the same behavior and an optimal transport near the localization delocalization (or metal-insulator) transition. It is important to note that even in this large system the transport time at the optimal phase breaking is still determined by the shape of the equilibrium distribution and the relaxation time is negligible. It seems advantageous for biologically relevant quantum transport to tune the system into the critical point of the localization-delocalization transition.

In the light harvesting case, the task of the system is to transport the exciton the fastest possible way to the reaction center whose position is known. In a computational task we usually would like to find the minimum of some complex function ƒₙ. For the simplicity let this function have only discrete values from 0 to K. If we are able to map the values of this function to the electrostatic site energies of the chromophores Hₙₘ=ε_{Q}fₙ and we deploy reaction centers near to them trapping the excitons with some rate κ and can access the current at each reaction center it will be proportional with the probability to find the exciton on the chromophore jₙ˜κρₙₘ. Since the excitons will explore the Boltzmann distribution the currents will reflect that jₙ=κ [symbol] n|e^{-βH}|n [symbol] /Z . There are three conditions which should be valid simultaneously: 1) The system should operate at the optimal phase breaking which then should be in the order of magnitude of the energy steps γ_{φ}˜O(ε₀). 2) In the worst case scenario the minimum current is elevated with a factor e^{βε}₀ relative to the second smallest minimum. To be able to detect this, the energies should be of the order of the thermal energy ε₀˜O(k_{B}T). 3) The hopping terms Hₙₘ between the chromophores should be optimal to keep the system at the border of the localization-delocalization transition. The first two conditions can be easily met since the phase breaking is usually of the same order as the thermal energy γ_{φ}˜k_{B}T. The third condition can be realized by placing the chromophores interacting via the dipole interaction to an optimal distance from each other randomly so that the quasi random Hₙₘ matrix elements keep the system at the localization-delocalization threshold. Conversely, given a random arrangement of Hₙₘ-s the parameter ε₀ can be tuned so that the system gets to the localization-delocalization threshold. In some cases, the localization length can be calculated and the distance between the chromophores can be adjusted until a suitable localization length is provided (e.g., at or near the localization-delocalization threshold). For example, the distance between the chromophores can provide a localization length that is about halfway between fully localized and fully extended.

This quantum-classical optimization method discovered by evolution seems to be superior to the optimization methods developed so far. Classical stochastic optimization techniques can be trapped in local minima for long times and careful annealing techniques are required to reach the correct minimum. Even then sites are discovered in a classical sequential manner and it takes the process long times to find the minimum. Quantum mechanics is more advantageous as it is able to explore the sites in parallel, but the discovery process is hampered by Anderson localization especially near local minima. An optimal amount of phase breaking can destroy the interferences causing this and can ensure the ergodic exploration of the states while quantum dissipation takes all the advantages of the classical stochastic optimization and establishes the Boltzmann distribution which elevates the proper minimum. The physical speed of the process is determined by the inverse trapping rate 1/κ which is in the order of picoseconds.

Current computers operate with about 4 GHz processors, where the cycle time of logical operations is 250 picoseconds. Computers based on artificial light harvesting complexes could have units with 100-1000 times larger efficiency at room temperature. But, it is also possible to realize such systems on excitons of organic molecules or on Hamiltonians arising in nuclear matter, which would provide a virtually endless source of improvement both in time and miniaturization below the atomic scale.

### General Structure of the Exciton Transistor

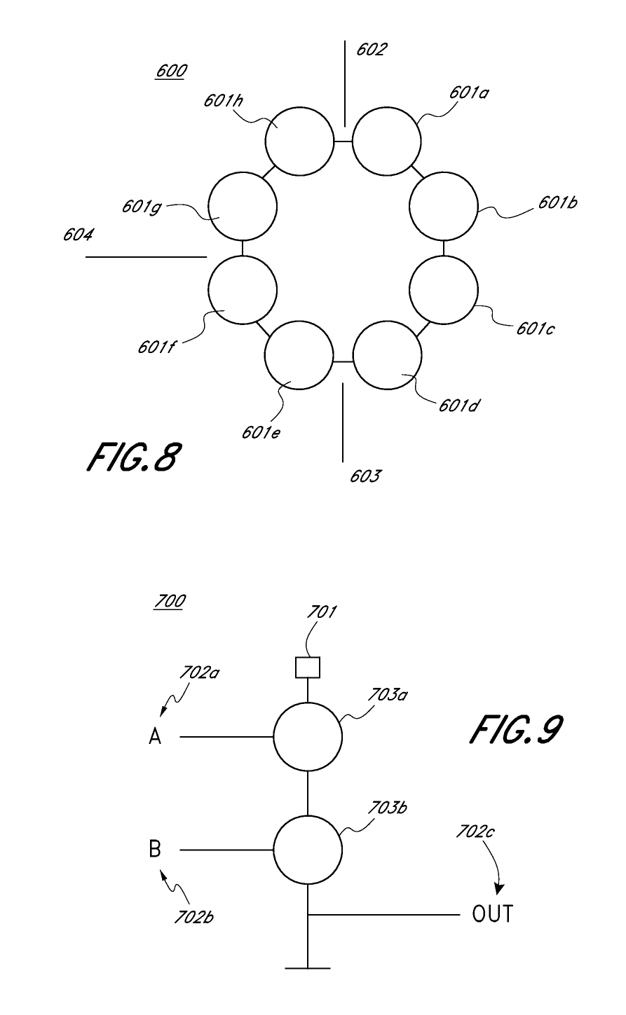

FIG. 8 is a structural diagram of several chromophores 601a-h arranged in a chromophore ring as discussed in certain of the embodiments so as to form an exciton transistor element. Although shown here as consisting of 8 chromophores, one will recognize that as few as two chromophores may be used in certain embodiments. The timing and intensity of incident photons upon one of the chromophores, via an input such as 604, may modulate the probability of the gate to pass through an exciton via the remaining chromophores. That is, providing photons at input 604 may prepare the chromophore structure for the passage of excitons via input 602 and output 603. The timing and intensity of incident photons serve as a switching function that affects the transport of excitons through the gate in a manner similar to the voltage response of an electronic transistor. The incoming exciton may oscillate between each of the chromophores 601a-h. The timing and intensity of incident photons modulates the probability of the gate to pass through the exciton. The chromophores of FIG. 8 may form an information or energy conveyance structure, wherein the chromophore assembly comprises a spatial configuration that places the assembly within a pre-determined range of quantum order. For example, in some embodiments, the chromophores can be disposed in a quasi random matrix, which can facilitate holding the chromophores at the localization-delocalization threshold, as discussed herein. The pre-determined range may be selected to include a critical transition point between quantum order and quantum chaos. For example, the energy level spacing distribution of at least one quantum degree of freedom in the assembly approximately follows the function: p(s)=4s exp(−2s), wherein s is energy level spacing and p(s) is the determined energy level spacing distribution. The rate of coherence decay of at least one quantum degree of freedom in the assembly follows a power law. A chromophore modulator configured to modulate the probability that at least one chromophore in the assembly will transmit the exciton.

FIG. 9 illustrates an excitonic transistor pair arrangement organized so as to form an “AND” gate. The structure is similar to a traditional semiconductor transistor logic AND gate, where excitons and/or quantum information may be substituted, mutatis mutandis, for electrons in the traditional system. Here, in FIG. 9, an information or exciton source 701 (analogous to input 602 in FIG. 8), produces excitons. This source may be adjacent chromophore structures transmitting an exciton or may be a photon emission system (e.g., a laser source or other photon generator) that generates an exciton in the chromophore structure 703a upon absorption of a photon. Input A (analogous to input 604 in FIG. 8), which may be a photon emission system (e.g., a laser source), is coupled with the chromophore structure 703a, which may be the same or similar to the structure of FIG. 8. Chromophore structure 703a is itself coupled to chromophore structure 703b such that an exciton may be transferred from chromophore structure 703a to chromophore structure 703b. Chromophore structure 703b is also coupled to input 702b which may be a similar structure to input 702a. A sensor at output OUT 702c (analogous to output 603 in FIG. 8) may be used to determine the result of the logical operation. In some embodiments, the sensor is a photodetector that detects a photon emitted from a chromophore in chromophore structure 703b. Alternatively, the output may be a coupling to further chromophore structures such that may receive an exciton from chromophore structure 703b. As in a traditional transistor system, activation at both inputs A 702a and B 702b is necessary for information to be received at output OUT 702c. As described above with respect to FIG. 8, Inputs A 702a and B 702b may be a photon source (e.g., a laser source) that provides incident photons, the timing and intensity of which may modulate the probability of the respective chromophore structure 703a and 703b to pass through an exciton (e.g., by modulating the structures coherence properties). One will recognize that the inputs and outputs of the chromophore arrangement may be coupled to additional logical elements to form a logical network, as is the case mutatis mutandis in a traditional semiconductor system. Inputs A 702a and B 702b and output 702c may comprise conductive contacts.

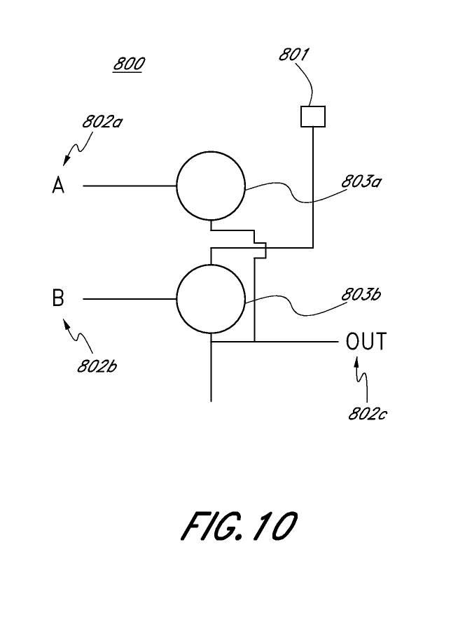

FIG. 10 illustrates an excitonic transistor pair arrangement organized so as to form an “OR” gate. As in FIG. 9, the structure is similar to a traditional semiconductor transistor logic OR gate, where excitons and/or quantum information may be substituted, mutatis mutandis, for electrons in the traditional system. Here, as in FIG. 9, an information or exciton source 801 produces excitons in the same manner as described above for exciton source 701. Input A, which may be a photon emission system, is coupled with the chromophore structure 803a, which may be the same or similar to the structure of FIG. 8. Chromophore structure 803a is itself coupled to chromophore structure 803b such that an exciton may be transferred from chromophore structure 803a to chromophore structure 803b. Chromophore structure 803b is also coupled to input 802b which may be a similar structure to input 802a. Alternatively, the output may be a coupling to further chromophore structures such that may receive an exciton from chromophore structure 803b. A sensor at output OUT 802c may be used to determine the result of the logical operation. As in a traditional transistor system, activation at both inputs A 802a and B 802b is necessary for information to be received at output OUT 802c. As in a traditional semiconductor system, one will recognize that activation of either input A 802a or input B 802b will result in the output 802c receiving excitons.

In an alternative embodiment of FIGS. 9 and 10, activation (or deactivation) of the chromophore structures may be accomplished by changing the potential of conductive contacts at inputs 702a-b and 802a-b. Manipulation of such contacts may affect the dipole characteristics of the chromophore, and thereby inhibit or promote exciton transfer accordingly. In some embodiments, varying the potential at contacts 702a-b and 802a-b may also affect the conformation of a scaffold, such as in a porphyrin skeleton, which may similarly affect exciton transfer. In such embodiments, ring-shaped chromophore structures may be replaced with linear structures, or alternatively, replaced with two ring-shaped structures connected by a linear structure, where the linear structure is in contact with the conductive inputs.

It will be appreciated that where the various structures depicted in FIGS. 9 and 10 are coupled to each other (as depicted by lines in FIGS. 9 and 10), the couplings may be achieved by linear arrays of chromophores. Such linear arrays can form nanowires capable of transmitting excitons from one end to the other.

### Construction of Chromophore Based Circuits

The nanocircuits illustrated in FIGS. 9 and 10 may be constructed by a plurality of means. The individual chromophore structures 703a-b and 803a-b may be constructed by synthesizing a porphyrin skeleton. In some embodiments the chromophore structures 703a-b and 803a-b may be synthesized in a genetically engineered system. For example, chromophores may be attached to virus molecules to facilitate self-assembly into a desired structure, possibly by introducing the virus into a biological entity which may then produce the chromophore structures in a desired configuration. The chromophore structures 703a-b and 803a-b may each comprise a plurality of chromophores arranged in a stacked and/or spiraling configuration. The biological entity may be a plant or animal.

The chromophore structures may be harvested from the biological entity and relocated to a controlled environment, such as a microfluidic system, conducive to the constructions of integrated logical circuits. The controlled environment may comprise a sheet having predetermined attachment points configured to attract the chromophore structures. Spraying the harvested chromophore structures upon the sheet would then result in the chromophores being affixed to the desired location, such as locations in communication with electrical contacts as discussed in relation to FIGS. 9 and 10. In this manner, a designer could prepare a sheet with predetermined attachment points pursuant to a desired circuit layout. In some embodiments the chromophores may comprise a dye coupled to a semiconductor surface.

### Selection of Chromophores

In some embodiments, the chromophore structures used as described herein exhibit critical quantum chaos. Experimentally, chromophore structures existing in this state can be identified by measuring the decay of coherence in the system. In a non-critical system the coherence decay is exponential in time. Critical quantum chaos is signaled by a slow, typically power law decay of coherence. State of the art coherence decay measurements are based on various echo measurements depending on the system studied. This includes spin echo, neuton spin echo, and photon echo.

In some embodiments, whether a candidate chromophore structure exhibits critical quantum chaos can be determined by analyzing the energy level spacing distribution of its quantum degrees of freedom (e.g., by using spectroscopic techniques). In a pure ordered regime, the energy level spacing distribution has the form:

p(s)=exp(−s)

where s is the energy level spacing and p(s) is the energy level spacing distribution. In a purely chaotic system, the distribution has the form:

$$p ( s ) = \frac{π s}{2} exp ( - π {s}^{2} \text{/} 4 )$$

At critical quantum chaos, the energy level spacing distribution has the form:

p(s)=4s exp(−2s).

The degree of closeness of the system to critical quantum chaos may determined by calculating the value:

$$x = \frac{A - {A}_{p}}{{A}_{w} - {A}_{p}}$$

$$where {A}_{p} = {\int }_{2}^{∞} {p}_{p} ( s ) , {A}_{w} = {\int }_{2}^{∞} {p}_{w} ( s ) , and A = {\int }_{2}^{∞} p ( s ) ,$$

where pₚ(s)=exp(−s) and

$${p}_{w} ( s ) = \frac{π s}{2} exp ( - π {s}^{2} \text{/} 4 ) .$$

p(s) is the experimentally determined energy level spacing distribution. The theoretical critical point is at x=0.475. In various embodiments, a chromophore assembly is provided with an x value between about 0.4 and about 0.6, between about 0.45 and about 0.55, between about 0.45 and about 0.5, and at about 0.475.

Further details regarding designing or identifying chromophore structures that exhibit critical quantum chaos may be found in PCT Application No. PCT/US2011/044738 (published as WO 2012/047356), which is incorporated herein by reference in its entirety.

Accordingly, in some embodiments, chromophore structures for use in the systems described herein are selected by analyzing rate of coherence decay and/or energy level spacing distribution of a selection of candidate chromophore structures. Those chromophore structures meeting the criteria described above are then used in the construction of a nanocircuit.

### Clarifications Regarding Terminology

Those having skill in the art will further appreciate that the various illustrative logical blocks, modules, circuits, and process steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. One skilled in the art will recognize that a portion, or a part, may comprise something less than, or equal to, a whole. For example, a portion of a collection of pixels may refer to a sub-collection of those pixels.

Headings are included herein for reference and to aid in locating various sections. These headings are not intended to limit the scope of the concepts described with respect thereto. Such concepts may have applicability throughout the entire specification.

The previous description of the disclosed implementations is provided to enable any person skilled in the art to make or use the present invention. Various modifications to these implementations will be readily apparent to those skilled in the art, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

What is claimed is:

1. An information or energy conveyance structure, comprising a chromophore assembly that comprises a plurality of chromophores in a spatial configuration that places the chromophore assembly within a pre-determined range of quantum order.

2. The structure of claim 1, wherein the pre-determined range of quantum order includes a critical transition point between quantum order and quantum chaos.

3. The structure of claim 2, wherein the energy level spacing distribution of at least one quantum degree of freedom in the chromophore assembly approximately follows the function: p(s)=4s exp(−2s), wherein s is energy level spacing and p(s) is the determined energy level spacing distribution.

4. The structure of claim 2, wherein the rate of coherence decay of at least one quantum degree of freedom in the chromophore assembly follows a power law.

5. The structure of claim 1, wherein spatial configuration comprises a loop.

6. The structure of claim 1, wherein the spatial configuration comprises a quasi random matrix.

7. The structure of claim 1, wherein at least one of the plurality of chromophores are embedded in a protein scaffold, the scaffold configured to suppress thermal fluctuations.

8. An apparatus for performing logical operations, the apparatus comprising:
a chromophore assembly that comprises a plurality of chromophores in a spatial configuration that places the chromophore assembly within a pre-determined range of quantum order;
an exciton source configured to input an exciton into the chromophore assembly; and
a chromophore modulator configured to modulate the probability that at least one chromophore in the chromophore assembly will transmit the exciton.

9. The apparatus of claim 8, wherein the exciton source comprises a photon generator.

10. The apparatus of claim 9, wherein the photon generator comprises a laser.

11. The apparatus of claim 8, wherein the exciton source comprises a chromophore.

12. The apparatus of claim 8, wherein the chromophore modulator comprises a photon generator.

13. The apparatus of claim 12, wherein the photon generator comprises a laser.

14. The apparatus of claim 8, wherein the chromophore modulator comprises a conductive contact.

15. The apparatus of claim 8, further comprising a detector configured to detect the presence of the exciton at a pre-determined location within the assembly.

16. The apparatus of claim 15, wherein the detector comprises a photodetector configured to detect a photon emitted from a chromophore within the assemply at the pre-determined location.

17. The structure of claim 8, wherein the pre-determined range of quantum order includes a critical transition point between quantum order and quantum chaos.

18. The structure of claim 17, wherein the energy level spacing distribution of at least one quantum degree of freedom in the assembly approximately follows the function: p(s)=4s exp(−2s), wherein s is energy level spacing and p(s) is the determined energy level spacing distribution.

19. The structure of claim 17, wherein the rate of coherence decay of at least one quantum degree of freedom in the assembly follows a power law.

20. The structure of claim 8, wherein spatial configuration comprises a loop.

21. An apparatus for performing logical operations, the apparatus comprising:
a first module configured to apply external driving to a transmission element such that the transmission element's degree of quantum coherence exceeds a first threshold, wherein the first module drives the transmission element based on a first input, the first input configured to receive quantum information;
a second module configured to maintain a state associated with the transmission element within a range of a transition point;
a third module configured to apply time dependent forces to the transmission element thereby reducing the transmission element's degree of quantum coherence below a second threshold; and
an output configured to transmit quantum information.

22. The apparatus of claim 21, wherein the transmission element comprises light absorbing and emitting chromophores embedded in a protein scaffold, the scaffold configured to suppress thermal fluctuations.

23. The apparatus of claim 21, further comprising a fourth module configured to measure the coherence of the transmission element.

24. The apparatus of claim 21, wherein the transmission element comprises a chromophore in a ring of chromophores.

25. The apparatus of claim 21, wherein the second module comprises a photon emitter.

26. The apparatus of claim 21, wherein the third module comprises a photon emitter.

27. The apparatus of claim 21, wherein the transition point comprises a metal-insulator transition.

28. The apparatus of claim 21, wherein the transition point comprises a localization-delocalization transition.

29. The apparatus of claim 21, wherein the transition point comprises a critical transition point between quantum order and quantum chaos.

30. A method for performing logical operations, the method comprising:
receiving quantum information at a first input;
applying an external driving to a transmission element such that the transmission element's degree of quantum coherence exceeds a first threshold,
maintaining a state associated with the transmission element within a range of a transition point;
applying time dependent forces to the transmission element thereby reducing the transmission element's degree of quantum coherence below a second threshold; and
transmitting quantum information via an output.

31. An apparatus for performing logical operations, the apparatus comprising:
an exciton source;
an output;
a first chromophore structure coupled between the exciton source and the output;
a first chromophore modulator configured to modulate the first chromophore structure between a first state and a second state;
a second chromophore structure coupled between the exciton source and the output; and
a second chromophore modulator configured to modulate the second chromophore structure between the first state and the second state.

32. The apparatus of claim 31, configured such that an exciton is transferred from the exciton source to the output when either the first chromophore structure or the second chromophore structure is in the first state.

33. The apparatus of claim 31, configured such that an exciton is transferred from the exciton source to the output when both the first chromophore structure and the second chromophore structure are in the first state, and the exciton is not transferred from the exciton source to the output when either the first chromophore structure or the second chromophore structure is in the second state.

34. The apparatus of claim 31, wherein the first chromophore modulator is configured to modulate the first chromophore structure between the first state and the second state by adjusting quantum coherence of the first chromophore structure.
